(19) United States
(12) Patent Application Publication
(10) Pub. No.: US 2017/0051118 A1
(43) Pub. Date: Feb. 23, 2017

(54) PELLETS OF LIGHTLY VIS-BROKEN POLYPROPYLENE

(71) Applicant: FINA TECHNOLOGY, INC., Houston, TX (US)

(72) Inventors: Michael McLeod, Houston, TX (US); Douglas Burmaster, Houston, TX (US)

(21) Appl. No.: 14/832,350

(22) Filed: Aug. 21, 2015

(51) Int. Cl. C08J 5/00; C08F 110/06; C08J 3/24

(52) U.S. Cl. CPC C08J 5/00; C08J 3/24; C08F 110/06; C08J 2323/26

(57) ABSTRACT

A process including vis-breaking of polypropylene in the presence of 3,6,9-triethyl-3,6,9-trimethyl-1,4,7-triperoxonane to obtain vis-broken polypropylene is provided. The vis-broken polypropylene may be pelletized to obtain pellets. A ratio of a melt flow rate (MI₂) of the pellets to a melt flow rate (MI₂) of the polypropylene prior to the vis-breaking may be greater than 1:1 and at most 4:1. The pellets may be used to form articles.

### FIELD

Embodiments of the present disclosure generally relate to pelletized polyolefin. More particularly, embodiments of the present disclosure relate to pelletized, vis-broken polypropylene.

### BACKGROUND

Polyolefins, particularly polypropylene, may have its weight average molecular weight (Mw) decreased or its melt flow rate (MFR) increased by controlled degradation of the polymer. Controlled degradation of polyolefin may be accomplished by reaction with a free radical generator during which polymer molecule scission occurs, resulting in an overall lowered molecular weight or elevated melt flow rate. Such controlled degradation is also referred to as vis-breaking, controlled rheology, or peroxide degradation. As economic efficiencies encourage fewer polymerization reactor changes, the ability to produce improved vis-broken polymer grades has increased relevance.

Vis-broken polyolefins may be processed by pelletization to form polymeric pellets, which may be subsequently used in other applications, such as the formation of articles.

### SUMMARY

The present disclosure provides for a process. The process includes vis-breaking polypropylene in the presence of 3,6,9-triethyl-3,6,9-trimethyl-1,4,7-triperoxonane to obtain vis-broken polypropylene. The process includes pelletizing the vis-broken polypropylene to obtain pellets. A ratio of a melt flow rate (MI₂) of the pellets to a melt flow rate (MI₂) of the polypropylene prior to the vis-breaking is greater than 1:1 and at most 4:1. The melt flow rates (MI₂) are determined in accordance with ASTM D-1238 at 190° C. and a load of 2.16 kg.

The present disclosure provides for a process that includes vis-breaking polypropylene in the presence of 3,6,9-triethyl-3,6,9-trimethyl-1,4,7-triperoxonane to obtain vis-broken polypropylene. A ratio of a melt flow rate (MI₂) of the vis-broken polypropylene to a melt flow rate (MI₂) of the polypropylene prior to the vis-breaking is greater than 1:1 and at most 4:1. The melt flow rates (MI₂) are determined in accordance with ASTM D-1238 at 190° C. and a load of 2.16 kg.

The present disclosure provides for polypropylene vis-broken in the presence of 3,6,9-triethyl-3,6,9-trimethyl-1,4,7-triperoxonane. A ratio of a melt flow rate (MI₂) of the pellets to a melt flow rate (MI₂) of the polypropylene prior to the vis-breaking is greater than 1:1 and at most 4:1. The melt flow rates (MI₂) are determined in accordance with ASTM D-1238 at 190° C. and a load of 2.16 kg.

The present disclosure provides for pellets of polypropylene vis-broken in the presence of 3,6,9-triethyl-3,6,9-trimethyl-1,4,7-triperoxonane. A ratio of a melt flow rate (MI₂) of the pellets to a melt flow rate (MI₂) of the polypropylene prior to the vis-breaking is greater than 1:1 and at most 4:1. The melt flow rates (MI₂) are determined in accordance with ASTM D-1238 at 190° C. and a load of 2.16 kg.

### BRIEF DESCRIPTION OF DRAWINGS

The present disclosure may be understood from the following detailed description when read with the accompanying figures.

FIGS. 1A-1D depict various polymeric pellets.

FIG. 2 depicts a flow diagram of a process in accordance with one or more embodiments.

### DETAILED DESCRIPTION

A detailed description will now be provided. The following disclosure includes specific embodiments, versions and examples, but the disclosure is not limited to these embodiments, versions or examples, which are included to enable a person having ordinary skill in the art to make and use the disclosure when the information in this application is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Certain embodiments of the present disclosure relate to a process of forming polymeric pellets. The process includes vis-breaking polypropylene in the presence of 3,6,9-triethyl-3,6,9-trimethyl-1,4,7-triperoxonane to obtain vis-broken polypropylene. The 3,6,9-triethyl-3,6,9-trimethyl-1,4,7-triperoxonane may be present in the vis-broken polypropylene in an amount ranging from greater than 0 ppm to at most 400 ppm, or 50 ppm to 350 ppm, or 100 ppm to 300 ppm, or 150 ppm to 250 ppm (all by weight), for example. Vis-breaking polypropylene may include contacting the polypropylene with 3,6,9-triethyl-3,6,9-trimethyl-1,4,7-triperoxonane under conditions sufficient to induce reaction of the 3,6,9-triethyl-3,6,9-trimethyl-1,4,7-triperoxonane with the polypropylene to result in scission of polypropylene molecules such that the melt flow rate of the vis-broken polypropylene is increased relative to the melt flow rate of the polypropylene prior to vis-breaking. Conditions sufficient to induce reaction of the 3,6,9-triethyl-3,6,9-trimethyl-1,4,7-triperoxonane with the polypropylene to result in scission of polypropylene molecules may include mixing, shearing, subjection to strain, heating, or combinations thereof. For example and without limitation, conditions sufficient to induce reaction of the 3,6,9-triethyl-3,6,9-trimethyl-1,4,7-triperoxonane with the polypropylene to result in scission of polypropylene molecules may include heating 3,6,9-triethyl-3,6,9-trimethyl-1,4,7-triperoxonane and polypropylene to a temperature sufficient for melt extrusion, mixing 3,6,9-triethyl-3,6,9-trimethyl-1,4,7-triperoxonane and polypropylene, extruding a mixture of 3,6,9-triethyl-3,6,9-trimethyl-1,4,7-triperoxonane and polypropylene, or combinations thereof. Vis-breaking is governed by an Arrhenius relationship, and conditions sufficient to induce a vis-breaking reaction between 3,6,9-triethyl-3,6,9-trimethyl-1,4,7-triperoxonane and polypropylene may vary widely depending upon equipment used and initial melt flow rate of polypropylene, for example. For example and without limitation, the vis-breaking reaction may occur at an extrusion temperature ranging from about 140 to 330° C. or about 190 to 290° C.; an extrusion residence time ranging from about 15 seconds to about 5 minutes or 30 seconds to about 3 minutes; and a pressure ranging from about 100 to 7000 psi or about 300 to about 3000 psi, or about 500 to 2500 psi, or about 1000 to about 2300 psi, or about 1500 to about 2200 psi, or about 2000 psi.

In some embodiments, vis-breaking of the polypropylene includes melt-compounding the polypropylene with the 3,6,9-triethyl-3,6,9-trimethyl-1,4,7-triperoxonane. Melt-compounding the polypropylene with the 3,6,9-triethyl-3,6,9-trimethyl-1,4,7-triperoxonane may be performed by melt extrusion in an extruder, such as a single or twin screw extruder, for example.

In certain embodiments, the polypropylene is not vis-broken in the presence of 2,5-bis(tert-butylperoxy)-2,5-dimethylhexane to obtain the vis-broken polypropylene, which is commercially available from AKZONOBEL® as LUPERSOL™ 101. In some embodiments, the polypropylene is not vis-broken in the presence of any free radical generator other than 3,6,9-triethyl-3,6,9-trimethyl-1,4,7-triperoxonane. For example and without limitation, free radical generators may include peroxides, such as organic peroxides.

In some embodiments, a ratio of a melt flow rate (MI₂) of the vis-broken polypropylene to a melt flow rate (MI₂) of the polypropylene prior to the vis-breaking is greater than 1:1 and at most 4:1, greater than 1:1 and at most 3:1, greater than 1:1 and at most 2.5:1, or greater than 1:1 and at most 2:1. For example and without limitation, the melt flow rates may be determined using a dead-weight piston Plastometer that extrudes polypropylene through an orifice of specified dimensions at a temperature of 230° C. and a load of 2.16 kg in accordance with ASTM D1238. Unless otherwise stated, all melt flow rates (MI₂) disclosed herein are determined in accordance with ASTM D-1238 at 190° C. and a load of 2.16 kg.

In some embodiments, the process includes pelletizing the vis-broken polypropylene to obtain pellets. For example and without limitation, a stand of the vis-broken polypropylene may exit and extruder through a die hole. Pelletization may include cutting the strand into pellets as the strand exits the extruder through the die hole. For example and without limitation, a knife may cut the strand into pellets as the strand exits the extruder through the die hole.

In some embodiments, a ratio of a melt flow rate (MI₂) of the pellets to a melt flow rate (MI₂) of the polypropylene prior to the vis-breaking is greater than 1:1 and at most 4:1, or greater than 1:1 and at most 3:1, or greater than 1:1 and at most 2.5:1.

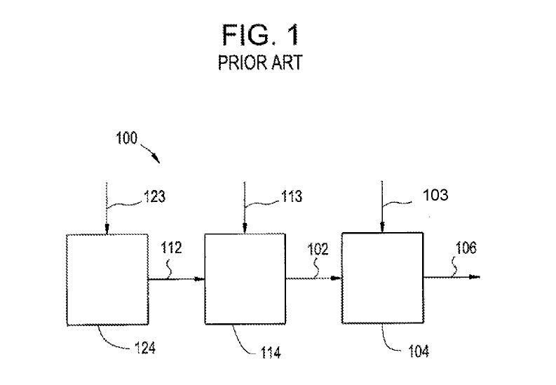

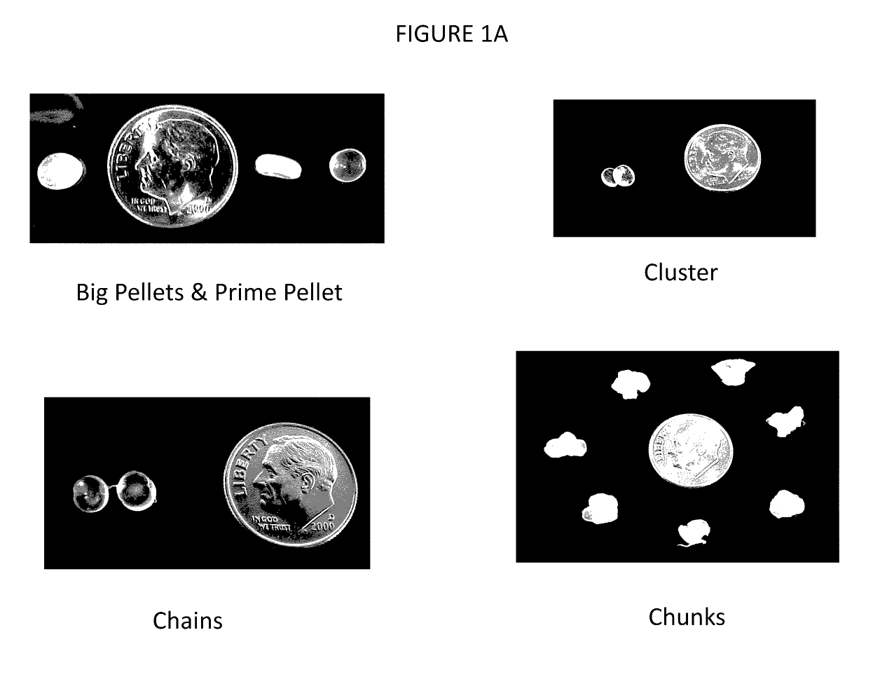

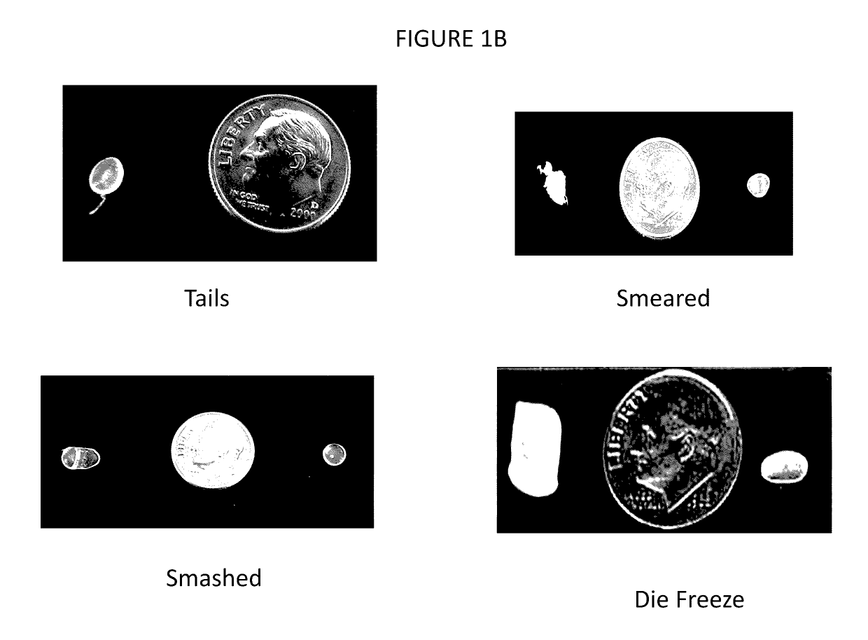

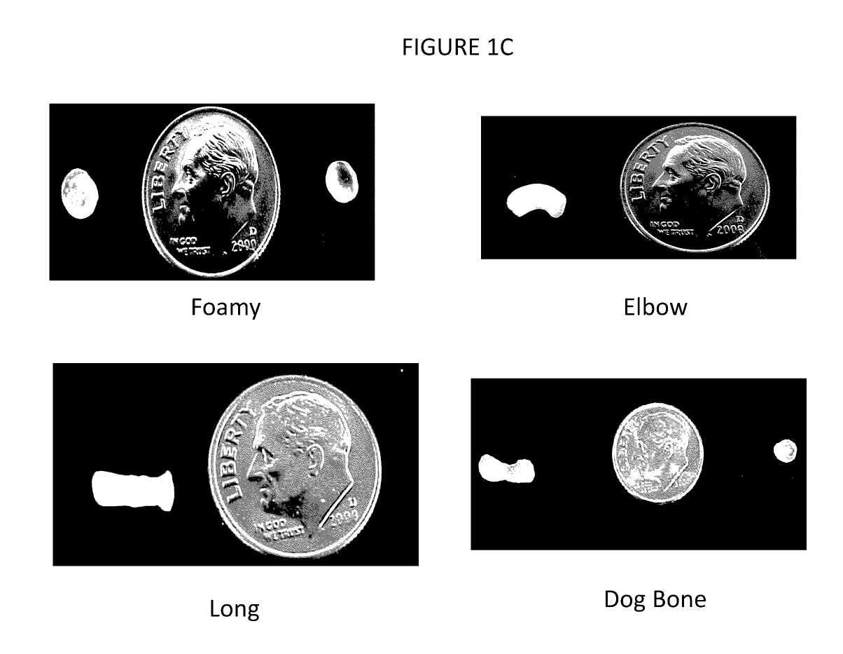

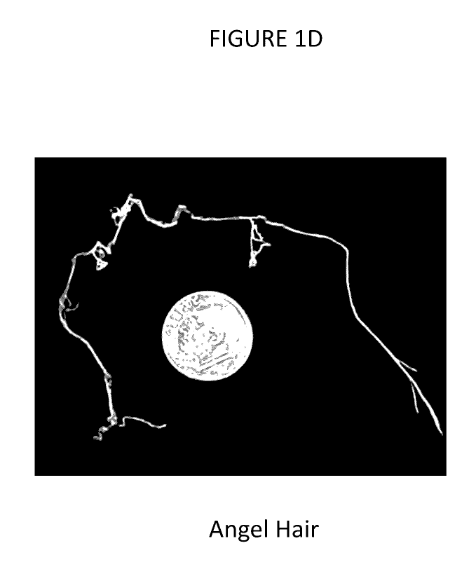

The process may be characterized by a reduction in the production of marginal and off-grade pellets in comparison to an otherwise identical process in which polypropylene is not vis-broken in the presence of 3,6,9-triethyl-3,6,9-trimethyl-1,4,7-triperoxonane, but is vis-broken in the presence of a free radical generator other than 3,6,9-triethyl-3,6,9-trimethyl-1,4,7-triperoxonane, such as of 2,5-bis(tert-butylperoxy)-2,5-dimethylhexane. For example and without limitation, the process may include production of generally spherical pellets of a generally uniform desired size, also referred to herein as prime pellets. As used herein, marginal and off-grade pellets may include pellets that are not generally spherical, not of the generally uniform desired size, or combinations thereof. For example and without limitation, marginal and off-grade pellets may include long pellets, big pellets, pellets of non-uniform size (e.g. chunks), pellets having a tail, clusters of pellets, chains of pellets, smeared pellets, smashed pellets, die freeze pellets, foamy pellets, elbows, angel hair, dog bones, or combinations thereof, as depicted in FIGS. 1A-1D. Long pellets include pellets that are longer in at least one direction than the prime pellets. Big pellets are pellets that may be generally spherical, but are larger in diameter than the prime pellets. Pellets of non-uniform size include any pellets not of the generally uniform desired size, such as chunks. Pellets having a tail are pellets that have a protrusion on an edge of the pellet that is small relative to the pellet. Clusters of pellets are groupings of pellets stuck together. Smeared pellets are pellets having a generally flattened and smeared shape relative to the generally spherical shape of the prime pellets. Dog bones are pellets generally having the shape of a dog bone. Chains of pellets include two or more pellets connected by a relatively thin “link” of polymeric material. Smashed pellets include pellets that have been smashed. Die freeze pellets include pellets that have solidified in the die hole. Elbows include pellets having the general shape of an elbow or macaroni. Foamy pellets include pellets containing gaseous bubbles or voids. Angel hair includes thin strands of polymeric material not in the form of pellets.

In some embodiments, whether or not a pellet is a prime pellet, a marginal pellet, or an off-grade pellet may be determined by visual inspection. A scale may be established ranging from ‘0’ to ‘4’, in which ‘0’ is defined as pellets that most closely visually appear to be prime pellets; ‘1’ is defined as pellets that visually appear to be prime pellets less than pellets rated ‘0’, but more than pellets rate ‘2’; ‘2’ is defined as pellets that visually appear to be prime pellets less than pellets rated ‘1’, but more than pellets rate ‘3’; and ‘4’ is defined as pellets that least closely visually appear to be prime pellets. In such a scale, pellets rated ‘0’, ‘1’, and ‘2’ may be defined as prime pellets, whereas pellets rated ‘3’ and ‘4’ may be defined as marginal pellets and off-grade pellets. In some embodiments, the process is characterized by a production rate of prime pellets that is greater than 90%, and a production rate of marginal and off-grade pellets of less than 10%. A production rate of prime pellets that is greater than 90% means that greater than 90% by number of pellets produced are rated as prime pellets (e.g., rated ‘0’, ‘1’, or ‘2’ by visual inspection), and less than 10% by number of pellets produced are rated as marginal or off-grade pellets (e.g., rated ‘3’ or ‘4’ by visual inspection). In some embodiments, the process is characterized by a production rate of prime pellets that is greater than 95%, and a production rate of marginal and off-grade pellets of less than 5%. In some embodiments, the process is characterized by a production rate of prime pellets that is greater than 99%, and a production rate of marginal and off-grade pellets of less than 1%. In some embodiments, the process is characterized by elimination in the production of marginal and off-grade pellets, in which a production rate of prime pellets is 100% and a production rate of marginal and off-grade pellets is 0%.

### 3,6,9-triethyl-3,6,9-trimethyl-1,4,7-triperoxonane

The free radical generator, 3,6,9-triethyl-3,6,9-trimethyl-1,4,7-triperoxonane, is an organic peroxide that is commercially available from AKZONOBEL® under the tradename TRIGONOX® 301. TRIGONOX® 301 is generally available commercially as a 41% solution in an isoparaffinic hydrocarbon (e.g. ISOPAR® M, commercially available from EXXONMOBIL®). Some properties of TRIGONOX® 301 are set forth in Table 1.

TABLE 1
TRIGONOX ® 301

| | | Active Oxygen | | |
|---|---|---|---|---|
| | Molecular | Content | Appearance at | Active |
| Tradename | Weight | Peroxide | 25° C. | Oxygen |
| TRIGONOX ® | 264.3 | 18.16% | Clear to | 7.3-7.6% |
| 301 | | | slightly hazy | |
| | | | liquid | |

The reactivity of organic peroxides is typically given by its half-life (t_{1/2}) at various temperatures. For example, the half-life of TRIGONOX® 301 in chlorobenzene is: 0.1 hours at 170° C. (338° F.); 1 hour at 146° C. (295° F.); and 10 hours at 125° C. (257° F.). The half-life at other temperatures may be calculated using the following equations and constants:

K_{d}=A·e^{-Ea/RT}

T_{1/2}=(ln 2)/k_{d}

Eₐ=150.23 kJ/mole

A=1.02E+15 s⁻¹

R=8.3142 J/mole·K

T=(273.15+° C.)K

As discussed above, the amount of 3,6,9-triethyl-3,6,9-trimethyl-1,4,7-triperoxonane used is 400 ppm or less. Thus, when using a 41% solution in an isoparaffinic hydrocarbon, an amount of the solution used would be 980 ppm or less, such that the amount of 3,6,9-triethyl-3,6,9-trimethyl-1,4,7-triperoxonane is maintained at 400 ppm or less. Maintaining the amount of 3,6,9-triethyl-3,6,9-trimethyl-1,4,7-triperoxonane at 400 ppm or less allows for the attainment of a ratio of a melt flow rate (MI₂) of the pellets to a melt flow rate (MI₂) of the polypropylene prior to the vis-breaking is greater than 1:1 and at most 4:1.

### Polymer

In some embodiments, prior to vis-breaking the polypropylene is a reactor grade polypropylene in the form of a powder, granules, or fluff. The reactor grade polypropylene may be obtained directly from a polymerization reactor in which it is produced, optionally without any further processing prior to vis-breaking.

The polypropylene may have at least about 50 wt. %, or at least about 70 wt. %, or at least about 75 wt. %, or at least about 80 wt. %, or at least about 85 wt. %, or at least about 90 wt. %, or at least 95 wt. %, or at least 99 wt. % or about 100 wt. % polypropylene relative to the total weight of polymer, for example.

In some embodiments, the polypropylene may be, for instance, a propylene homopolymer, a propylene random copolymer, a propylene impact copolymer, a syndiotactic polypropylene, isotactic polypropylene or atactic polypropylene. In other embodiments, the propylene-based polymers may be a “mini-random” polypropylene. A mini-random polypropylene has less than about 1.0 wt % of the comonomer. In certain embodiments, the comonomer in the mini-random polypropylene is ethylene.

Polypropylene impact copolymers may include a polypropylene homopolymer phase or component joined to a copolymer phase or component. The polypropylene impact copolymer may have greater than 6.5 wt. % to less than 20 wt. % ethylene, or from 8.5 wt. % to less than 18 wt. % ethylene, or from 9.5 wt. % to less than 16% ethylene based on the total weight of the polypropylene impact copolymer.

The copolymer phase of the polypropylene impact copolymer may be a random copolymer of propylene and ethylene, also referred to as an ethylene/propylene rubber (EPR). Polypropylene impact copolymer show distinct homopolymer phases that are interrupted by short sequences or blocks having a random arrangement of ethylene and propylene. In comparison to random copolymers, the block segments including the EPR may have certain polymeric characteristics (e.g., intrinsic viscosity) that differ from that of the copolymer as a whole. Without wishing to be limited by theory, the EPR portion of the polypropylene impact copolymer has rubbery characteristics which, when incorporated within the matrix of the homopolymer component, may function to provide increased impact strength to the polypropylene impact copolymer. In an embodiment, the EPR portion of the polypropylene impact copolymer forms greater than 14 wt. % of the polypropylene impact copolymer, alternatively greater than 18 wt. % of the polypropylene impact copolymer, alternatively from 14 wt. % to 18 wt. % of the polypropylene impact copolymer.

The amount of ethylene present in the EPR portion of the polypropylene impact copolymer may be from 38 wt. % to 50 wt. %, alternatively from 40 wt. % to 45 wt. % based on the total weight of the EPR portion. The amount of ethylene present in the EPR portion of the polypropylene impact copolymer may be determined spectrophotometrically using a fourier transform infrared spectroscopy (FTIR) method. Specifically, the FTIR spectrum of a polymeric sample is recorded for a series of samples having a known EPR ethylene content. The ratio of transmittance at 720 cm⁻¹/900 cm⁻¹ is calculated for each ethylene concentration and a calibration curve may then be constructed. Linear regression analysis on the calibration curve can then be carried out to derive an equation that is then used to determine the EPR ethylene content for a sample material.

The EPR portion of the polypropylene impact copolymer may exhibit an intrinsic viscosity different from that of the propylene homopolymer component. Herein intrinsic viscosity refers to the capability of a polymer in solution to increase the viscosity of said solution. Viscosity is defined herein as the resistance to flow due to internal friction. In an embodiment, the intrinsic viscosity of the EPR portion of the polypropylene impact copolymer may be greater than 1 dl/g, alternatively from 2.0 dl/g to 3.0 dl/g, alternatively from 2.4 dl/g to 3.0 dl/g, alternatively from 2.4 dl/g to 2.7 dl/g, alternatively from 2.6 dl/g to 2.8 dl/g. The intrinsic viscosity of the EPR portion of the polypropylene impact copolymer is determined in accordance with ASTM D5225.

In an embodiment, the polypropylene impact copolymer may have a melt flow rate (MFR) of from 0.5 g/10 min. to 500 g/10 min., or from 1 g/10 min. to 100 g/10 min., or from 1.5 g/10 min. to 50 g/10 min., or from 2.0 g/10 min. to 20 g/10 min, or from 30 g/10 min. to 70 g/10 min, or from 40 g/10 min. to 60 g/10 min, or about 50 g/10 min.

Excellent flow properties as indicated by a high MFR allow for high throughput manufacturing of molded polymeric components. In an embodiment, the polypropylene impact copolymer is a reactor grade resin without modification, which may also be termed a low order polypropylene.

Representative examples of suitable polypropylene impact copolymers include without limitation 4944WZ and 4944CWZ, which are commercially available from Total Petrochemicals USA, Inc. Certain resin properties, mechanical properties, and thermal properties of the resins 4944WZ and 4944CWZ are set forth in Tables 2A, 2B, and 2C, respectively.

TABLE 2A
Resin Properties

| | MFR, g/10 min, | | |
|---|---|---|---|
| | ASTM D1238 at a | | |
| | temperature of 230° C. | | |
| | and a load of | Density, g/cm³, | Melting Range, |
| Resin | 2.16 kg | ASTM D-1505 | ° C. |
| 4944WZ | 50 | 0.905 | 160-165 |
| 4944CWZ | 50 | 0.905 | 160-165 |

TABLE 2B
Mechanical Properties

| | | | | Izod Impact |
|---|---|---|---|---|
| | Tensile Strength | | Flexural | (Notched) @ |
| | at Yield, psi (MPa), | Elongation at | Modulus, psi (MPa), | 23° C., ft-lb/in |
| | ASTM D- | Yield, %, | ASTM D- | (J/m), ASTM D- |
| Resin | 638 | ASTM D-638 | 790 | 256 |
| 4944WZ | 3650 (25) | 5 | 195,000 (1,350) | 1.4 (75) |
| 4944CWZ | 3700 (25) | 5 | 210,000 (1,450) | 1.5 (80) |

TABLE 2C
Thermal Properties

| | Vicat Softening | |
|---|---|---|
| | Point, ° C., | Heat Deflection Temperature, |
| Resin | ASSTM D-1525 | ° C., ASTM D-648 |
| 4944WZ | 150 | 90 |
| 4944CWZ | 150 | 90 |

The polypropylene may also be a polypropylene homopolymer, high crystallinity polypropylene homopolymer, polypropylene random copolymer, or high melt strength polypropylene, including those disclosed in U.S. Patent Publication No. 2013/0253121 A1, which is herein incorporated by reference in its entirety.

In some embodiments, the polypropylene is the only polymer present in the pellets.

The polypropylene may contain one or more additives known to those of ordinary skill in the art. The additives may include stabilizers, lubricants, clarifiers, acid neutralizers, additives for radiation resistance, ultraviolet screening agents, oxidants, antioxidants, anti-static agents, ultraviolet light absorbents, fire retardants, anti-blocks, coefficient of friction modifiers, processing oils, mold release agents, coloring agents, pigments, nucleating agents, fillers, and the like. The additives may be suited for the particular needs or desires of a user or maker, and various combinations of the additives may be used.

### Articles

In some embodiments, the pellets may be processed to make an article, such as by methods known to those of ordinary skill in the art. For example and without limitation, the pellets may be processed by injection molding, fiber extrusion, film extrusion, sheet extrusion, pipe extrusion, blow molding, rotomolding, slush molding, injection-stretch blow molding or extrusion-thermoforming to produce an article. The article may be a container, fiber, film, sheet, pipe, packaging such as thin-walled packaging, or household article, for example.

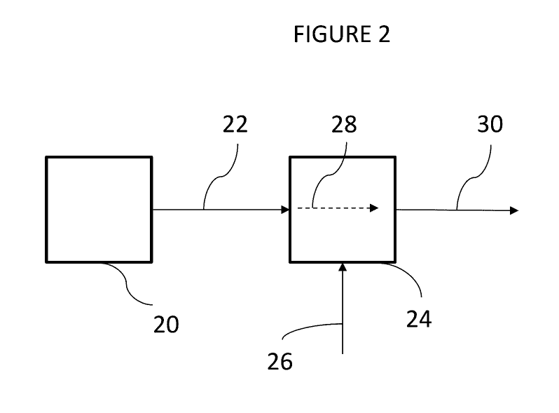

FIG. 2 depicts a flow diagram of the process in accordance with one or more embodiments. Polypropylene may be produced in polymerization reactor 20. The polypropylene may exit polymerization reactor 20 as reactor grade polypropylene 22 in the form of a powder, granules, or fluff, and enter extruder/pelletization apparatus 24. An amount of 3,6,9-triethyl-3,6,9-trimethyl-1,4,7-triperoxonane 26 may be introduced into extruder/pelltization apparatus 24. While depicted as being introduced separately into extruder/pelletization apparatus 24, in some embodiments 3,6,9-triethyl-3,6,9-trimethyl-1,4,7-triperoxonane 26 and reactor grade polypropylene 22 may be contacted prior to entering extruder/pelletization apparatus 24. Within extruder/pelltization apparatus 24, reactor grade polypropylene 22 and 3,6,9-triethyl-3,6,9-trimethyl-1,4,7-triperoxonane 26 may be subjected to conditions sufficient to induce reaction of 3,6,9-triethyl-3,6,9-trimethyl-1,4,7-triperoxonane 26 with reactor grade polypropylene 22 to result in scission of polypropylene molecules such that the melt flow rate of vis-broken polypropylene 28 is increased relative to the melt flow rate of reactor grade polypropylene 22 prior to vis-breaking. The conditions in extruder/pelletization apparatus 24 may include shearing, mixing, heating, or combinations thereof. As vis-broken polypropylene 28 exits extruder/pelletization apparatus 24 in the form of one or more strands, extruder/pelletization apparatus 24 may operate to cut vis-broken polypropylene 28 into pellets 30. Optionally, additional additives may also be melt-compounded with reactor grade polypropylene 22 within extruder/pelletization apparatus 24. For example and without limitation, extruder/pelletization apparatus 24 may be an extruder coupled with a pelletizer. The extruder may be a single or twin screw extruder, for example.

### Examples

The disclosure having been generally described, the following examples show particular embodiments of the disclosure. It is understood that the example is given by way of illustration and is not intended to limit the specification or the claims. All compositions percentages given in the examples are by weight.

Traditionally the resins 4944WZ and 4944CWZ are vis-broken such that a ratio of the melt flow rate of the resin after vis-breaking to the melt flow of the resin prior to vis-breaking is less than a 2:1 using 2,5-bis(tert-butylperoxy)-2,5-dimethylhexane, which is commercially available from AKZONOBEL® as LUPERSOL™ 101. 2,5-bis(tert-butylperoxy)-2,5-dimethylhexane has a molecular weight of 290.44 g/mol, active oxygen of 10.25 to 10.47%, and is commercially available as colorless to light yellow liquid.

4944WZ Tests—

Tests were performed in which a first sample of 4944WZ (Sample 1) was vis-broken in the presence of 2,5-bis(tert-butylperoxy)-2,5-dimethylhexane and a second sample of 4944WZ (Sample 2) was vis-broken in the presence of 3,6,9-triethyl-3,6,9-trimethyl-1,4,7-triperoxonane.

Pellets of vis-broken Sample 1 and vis-broken Sample 2 were produced. The pellets were visually inspected using a scale ranging from ‘0’ to ‘4’, in which ‘0’ is defined as pellets that most closely visually appear to be prime pellets; ‘1’ is defined as pellets that visually appear to be prime pellets less than pellets rated ‘0’, but more than pellets rate ‘2’; ‘2’ is defined as pellets that visually appear to be prime pellets less than pellets rated ‘1’, but more than pellets rate ‘3’; and ‘4’ is defined as pellets that least closely visually appear to be prime pellets. Pellets rated ‘0’, ‘1’, and ‘2’ were defined as prime pellets, whereas pellets rated ‘3’ and ‘4’ were defined as marginal pellets and off-grade pellets. The marginal and off-grade pellets included one or more of those defined above and depicted in FIGS. 1A-1D. Prime pellets include those of generally spherical shape and of a generally uniform desired size, as defined above and depicted in FIG. 1A. For example, the pellet on the far right of the “Big Pellets & Prime Pellet” picture in FIG. 1A is an example of a prime pellet.

4944WZ Data—Sample 1—

A total of 629 lots of pellets made from 4944WZ resin lightly vis-broken in the presence of LUPERSOL™ 101 were visually inspected. The 4944WZ was lightly vis-broken such that a ratio of a melt flow rate of the resin after vis-breaking to a melt flow rate of the resin prior to vis-breaking was greater than 1:1 and at most 4:1. Of the 629 lots of pellets of 4944WZ resin vis-broken in the presence of LUPERSOL™ 101, 208 lots were given the highest possible rating of ‘0’ (33.1%), and 63 lots were given a rating worse than “2” on at least one aspect of pellet appearance. This equates to 10.0% of production being marginal or off-grade. Commercially, the production of marginal or off-grade pellets undesirably requires waivers, negotiation or downgrading.

4944WZ Data—Sample 2—

A total of 191 lots of pellets of 4944WZ resin lightly vis-broken in the presence of TRIGONOX® 301 were visually inspected. The 4944WZ was lightly vis-broken such that a ratio of a melt flow rate of the resin after vis-breaking to a melt flow rate of the resin prior to vis-breaking was greater than 1:1 and at most 4:1. Of the 191 lots, 112 lots were given the highest possible rating of ‘0’ (58.6%), and none of the lots received a rating worse than ‘2’ on at least one aspect of pellet appearance. This equates to a 100% of production being first pass prime pellets by appearance rating.

4944CWZ Tests—

Tests were performed in which a first sample of 4944CWZ (Sample 3) was vis-broken in the presence of 2,5-bis(tert-butylperoxy)-2,5-dimethylhexane and a second sample of 4944CWZ (Sample 4) was vis-broken in the presence of 3,6,9-triethyl-3,6,9-trimethyl-1,4,7-triperoxonane.

Pellets of vis-broken Sample 3 and vis-broken Sample 4 were produced. The pellets were visually inspected using the scale ranging from ‘0’ to ‘4’, as defined above.

4944CWZ Data—Sample 3—

A total of 765 lots of pellets of 4944CWZ resin lightly vis-broken in the presence of LUPERSOL™ 101. The 4944CWZ was lightly vis-broken such that a ratio of a melt flow rate of the resin after vis-breaking to a melt flow rate of the resin prior to vis-breaking was greater than 1:1 and at most 4:1. Of the 765 lots of pellets of 4944CWZ resin vis-broken in the presence of LUPERSOL™ 101, 400 lots were given the highest possible rating of ‘0’ (52.3%), and 85 lots were given a rating worse than ‘2’ on at least one aspect of pellet appearance. This equates to 11.1% of production being marginal or off-grade.

4944CWZ Data—Sample 4—

A total of 316 lots of 4944CWZ were lightly vis-broken in the presence of TRIGONOX® 301. The 4944CWZ was lightly vis-broken such that a ratio of a melt flow rate of the resin after vis-breaking to a melt flow rate of the resin prior to vis-breaking was greater than 1:1 and at most 4:1. Of the 316 lots of 4944CWZ vis-broken in the presence of TRIGONOX® 301, 179 lots were given the highest possible rating of ‘0’ (56.6%), and none of the 316 lots received a rating worse than ‘2’ on at least one aspect of pellet appearance. As with 4944WZ vis-broken in the presence of TRIGONOX® 301, this equates with 100% of production being first pass prime pellets by appearance rating.

### Discussion of Results

The results of the Examples demonstrate that producing pellets from polypropylene that is vis-broken in the presence of 3,6,9-triethyl-3,6,9-trimethyl-1,4,7-triperoxonane unexpectedly leads to pellets that are more uniform in appearance, shape, and size in comparison to pellets produced from polypropylene that is vis-broken in the presence of 2,5-bis(tert-butylperoxy)-2,5-dimethylhexane. Thus, vis-breaking polypropylene in the presence of 3,6,9-triethyl-3,6,9-trimethyl-1,4,7-triperoxonane provides an improvement in pellet cut consistency when compared to other free radical generators, such as LUPERSOL™ 101.

Unexpectedly, these improved pellet properties were achieved in relatively lightly vis-broken resins, in which a ratio of a melt flow rate of the resin after vis-breaking to a melt flow rate of the resin prior to vis-breaking was greater than 1:1 and at most 4:1. Such improved pellet quality may yield improved production economics. For example and without limitation, the process may be characterized by the production of less scrap and more prime production yield. Also, the process may be characterized by a longer runtime between pelletizer knife changes.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

What is claimed:

1. A process for producing pellets comprising:
vis-breaking polypropylene in the presence of 3,6,9-triethyl-3,6,9-trimethyl-1,4,7-triperoxonane to obtain vis-broken polypropylene; and
pelletizing the vis-broken polypropylene to obtain pellets
wherein a ratio of a melt flow rate (MI₂) of the pellets to a melt flow rate (MI₂) of the polypropylene prior to the vis-breaking is greater than 1:1 and at most 2:1, and wherein the melt flow rates (MI₂) are determined in accordance with ASTM D-1238 at 190° C. and a load of 2.16 kg.

2. (canceled)

3. (canceled)

4. The process of claim 1, wherein the vis-breaking of the polypropylene comprises melt-compounding the polypropylene with the 3,6,9-triethyl-3,6,9-trimethyl-1,4,7-triperoxonane.

5. The process of claim 4, wherein the polypropylene is melt-compounded with the 3,6,9-triethyl-3,6,9-trimethyl-1,4,7-triperoxonane in an extruder.

6. The process of claim 1, wherein the polypropylene is an impact copolymer of polypropylene.

7. The process of claim 1, wherein, prior to vis-breaking, the polypropylene is a reactor grade polypropylene in the form of a powder, granules, or fluff.

8. The process of claim 1, wherein the 3,6,9-triethyl-3,6,9-trimethyl-1,4,7-triperoxonane is in solution in an isoparaffinic hydrocarbon when contacted with the polypropylene for vis-breaking the polypropylene.

9. (canceled)

10. The process of claim 1, wherein the free radical generator other than 3,6,9-triethyl-3,6,9-trimethyl-1,4,7-triperoxonane is 2,5-bis(tert-butylperoxy)-2,5-dimethylhexane.

11. The process of claim 1, wherein at least 99% of the pellets are generally spherical and of a generally uniform size.

12. The process of claim 1, wherein more than 90% of the pellets are generally spherical and of a generally uniform size.

13. The process of claim 1, wherein 3,6,9-triethyl-3,6,9-trimethyl-1,4,7-triperoxonane is present in the vis-broken polypropylene in an amount ranging from greater than 0 ppm to at most 400 ppm.

14. (canceled)

15. (canceled)

16. A process for producing pellets comprising:
adding 3,6,9-triethyl-3,6,9-trimethyl-1,4,7-triperoxonane to a polypropylene to obtain a vis-broken polypropylene, wherein a ratio of a melt flow rate (MI₂) of the vis-broken polypropylene to a melt flow rate (MI₂) of the polypropylene prior to the vis-breaking is greater than 1:1 and at most 4:1, and wherein the melt flow rates (MI₂) are determined in accordance with ASTM D-1238 at 190° C. and a load of 2.16 kg; and
pelletizing the vis-broken polypropylene, wherein more than 90% of the pellets are of generally spherical and of a generally uniform size.

17. The process of claim 16, wherein 100% of the pellets are generally spherical and of a generally uniform size.

18. (canceled)

19. (canceled)
